(19) United States
(12) Patent Application Publication
(10) Pub. No.: US 2019/0347603 A1
(43) Pub. Date: Nov. 14, 2019

(54) OPTIMIZING TURNAROUND BASED ON COMBINED CRITICAL PATHS

(71) Applicants: MSD International GMBH, Lucerne (CH); MSD IT Global Innovation Center s.r.o., Prague (CZ)

(72) Inventors: Pavel Vácha, Prague (CZ); Ondrej Slama, Beroun (CZ); Richard Dobis, Prague (CZ); Viktor Popovic, Presov (SK); Pavlo Minayev, Mataro (ES); Frank Walley, Waterford (IE); Charles Richard Walker, Waterford (IE)

(21) Appl. No.: 16/412,293

(22) Filed: May 14, 2019

Related U.S. Application Data
(60) Provisional application No. 62/671,388, filed on May 14, 2018.

(51) Int. Cl. G06Q 10/06; G06F 16/901; G06F 9/451

(52) U.S. Cl. CPC G06Q 10/063116; G06F 9/451; G06F 16/9024

(57) ABSTRACT

A turnaround management system receives a set of tasks. The turnaround management system generates a directed acyclic graph based on the received set of tasks. The turnaround management system determines longest paths through the graph and generates an optimal schedule for the set of tasks based on the determined longest paths. The turnaround management system may additionally analyze the optimal schedule for risk assessment or to predict delay.

### CROSS-REFERENCE TO RELATED APPLICATIONS

This application claims the benefit of U.S. Patent Application No. 62/671,388, filed May 14, 2018, which is incorporated by reference herein.

### TECHNICAL FIELD

The disclosure relates generally to automated scheduling and, in particular, to generating optimized schedules for constrained sets of tasks to display via a user interface.

### BACKGROUND

Many users and sets of users, such as organizations like businesses, charities, and universities, have sets of tasks to be completed using limited resources. For example, factories producing active pharmaceutical ingredients create a wide variety of products, each of which typically necessitates the customization of factory equipment prior to production. This customization phase, “turnaround,” often lasts for significant periods of time, during which products are not being produced using the involved factory resources. As such, lessening turnaround causes increased production, and therefore greater efficiency of use of the factory resources. Different products may require different chemicals, equipment, production processes, etc., or be limited by deadlines, which can all constrain the production. Production is further constrained by the limited resources of the factory, such as an amount of equipment, a number of available man hours, etc.

In general, sets of tasks to be completed using limited resources can be scheduled in a variety of ways, some of which may be more efficient than others. For example, for efficiency in terms of time, more efficient schedules finish all the tasks in the set of tasks more quickly than less efficient schedules. The most efficient schedule, e.g. the one with the shortest time to completion of all tasks, may be considered the optimized schedule. However, determining the optimized schedule (in terms of an efficiency metric) for a set of tasks can be difficult, particularly when the scheduling of the tasks is constrained, such as by limited resources.

### SUMMARY

A turnaround management system receives a set of tasks. Each task in the set of tasks includes one or more properties and may include one or more constraints. The turnaround management system generates a directed acyclic graph based on the received set of tasks. The graph includes task vertices representing tasks in the set of tasks and can include edges representing constraints upon one or more tasks in the set of tasks. One or more edges are weighted based on task properties, such as time and/or resources.

The turnaround management system iteratively determines a longest path through the graph and generates an optimal schedule for the set of tasks based on the determined longest path at each iteration. At the end of each iteration, at least some of the task vertices in the determined longest path may be removed from or flagged in the graph as no longer viable vertices for subsequent longest paths. The longest path may be based on time and/or resources as represented by weights within the graph. The turnaround management system may additionally analyze the optimal schedule for risk assessment, to predict delay, or to determine an optimality of the optimal schedule.

The turnaround management system may generate one or more user interfaces representing the optimal schedule or information pertaining to the optimal schedule. A first user interface the turnaround management system may generate is a table indicating the scheduling of the tasks in the set of tasks according to the optimal schedule. A second user interface the turnaround management system may generate is a table indicating dependencies of the tasks in the set of tasks, as scheduled according to the optimal schedule. A third user interface the turnaround management system may generate is a table indicating deadline satisfaction for tasks in the set of tasks, as scheduled according to the optimal schedule. A fourth user interface the turnaround management system may generate is a utilization chart indicating an efficiency of resource use for tasks in the set of tasks, as scheduled according to the optimal schedule. A fifth user interface the turnaround management system may generate is an equipment allocation chart, as scheduled according to the optimal schedule. The turnaround management system may send one or more generated user interfaces to a client device for display.

### BRIEF DESCRIPTION OF THE DRAWINGS

Figure (FIG. 1 illustrates an example computer system environment for a turnaround management system, according to one embodiment.

FIG. 2 illustrates an example block diagram of a turnaround optimization engine, according to one embodiment.

FIG. 3 illustrates an example directed acyclic graph that may be generated by a turnaround optimization engine, according to one embodiment.

FIG. 4A illustrates an example optimized schedule, according to one embodiment.

FIG. 4B illustrates an example optimized schedule displaying task dependencies, according to one embodiment.

FIG. 4C illustrates an example optimized schedule displaying task deadline satisfaction, according to one embodiment.

FIG. 4D illustrates an example utilization chart based on an optimized schedule, according to one embodiment.

FIG. 5 illustrates an example process flow for determining an optimized schedule, according to one embodiment.

FIG. 6 is a block diagram illustrating components of an example machine able to read instructions from a machine-readable medium and execute them in one or more processors (or controllers), in accordance with one example embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

FIG. 1 illustrates an example computer system environment 100 for a turnaround management system (TMS) 110, according to one embodiment. The TMS 110 generates schedules for sets of tasks and can generate one or more user interfaces to visually represent the generated schedules and/or information pertaining to the sets of tasks. The system environment 100 shown in FIG. 1 includes the TMS 110, a client device 120, and a database 140, which are connected to each other via a network 130. In other embodiments, different or additional entities can be included in the system environment. For example, though only one client device 120 and database 140 are shown in FIG. 1, the system environment may include additional client devices 120 and/or databases 140. Furthermore, in various embodiments the turnaround management system 110 and/or database 140 may be incorporated partially or entirely into the client device 120. Additionally, the functions performed by the various entities of FIG. 1 may vary in different embodiments.

A task is an operation to be completed. For example, at a chemical factory, tasks may be activities needed to be completed before production of an active pharmaceutical ingredient (API). This is a customization phase called “turnaround” and it can include tasks, like cleaning, testing, and configuration of factory equipment, so the equipment is prepared for production of an API. Tasks have properties, such as a temporal duration, one or more required resources, and a priority. Task properties may determine constraints or may themselves be considered constraints, depending upon the embodiment. Furthermore, tasks may be constrained by one another, such as one task not being able to be performed until the completion of another task—such as production of an API, which is often constrained by completion of one or more turnaround tasks.

In one embodiment, task constraints include “start after completion” (SAC), “start after start of a task” (SAS), “start together” (ST), “finish together” (FT), “available daily resources” (ADR), “start after date” (SAD), “finish before date” (FBD), “start after progress of a task” (SAP), “start right after completion of a task” (SRAC), and “start right at progress of task” (SRAP). A SAC constraint identifies one or more tasks to be performed after one or more other tasks complete. An SAS constraint identifies one or more tasks to be performed after one or more other tasks at least begin. An ST constraint identifies two or more tasks to start together. An FT constraint identifies two or more tasks to end together. An ADR constraint identifies an amount of resources available on a given day; tasks performed on the given day, taken together, may not have a sum total of required resources greater than the ADR. A SAD constraint identifies one or more tasks to be performed after a given date. An FBD constraint identifies one or more tasks to complete before a given date. A SAP constraint identifies one or more tasks to be performed after an amount of time since the start of, or upon a percentage of progress of, a particular task. A SRAC constraint identifies one or more tasks for which performance begins immediately upon completion of a particular task. A SRAP constraint identifies one or more tasks for which performance begins immediately after an amount of time since the start of, or upon a percentage of progress of, a particular task.

Often it is desirable to schedule the performance of tasks in a set of tasks in an optimized manner (or as near optimal as possible) to require as little time and/or resources as possible while still completing all of the tasks and factoring for their constraints. For example, at a chemical factory it may be desirable to schedule tasks such that there is as little turnaround and as much production as possible, as quickly as possible. However, scheduling various tasks while considering each task's properties and constraints can be complex and difficult. The large number of tasks and constraints involved in many modern manufacturing processes make this a high dimensional problem, rendering solutions using conventional techniques impossible (or at least highly impractical) within a time frame that would make the solution useful.

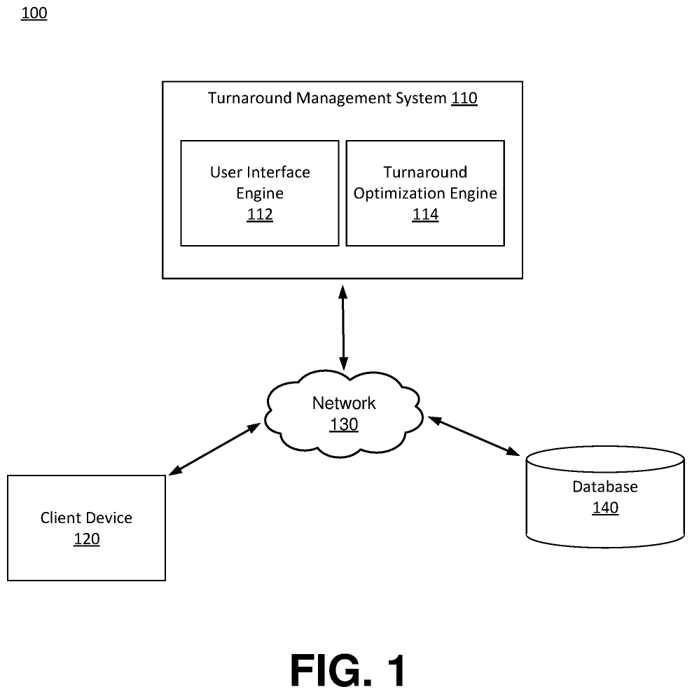

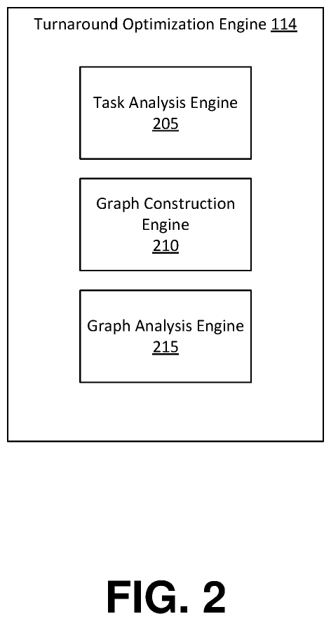

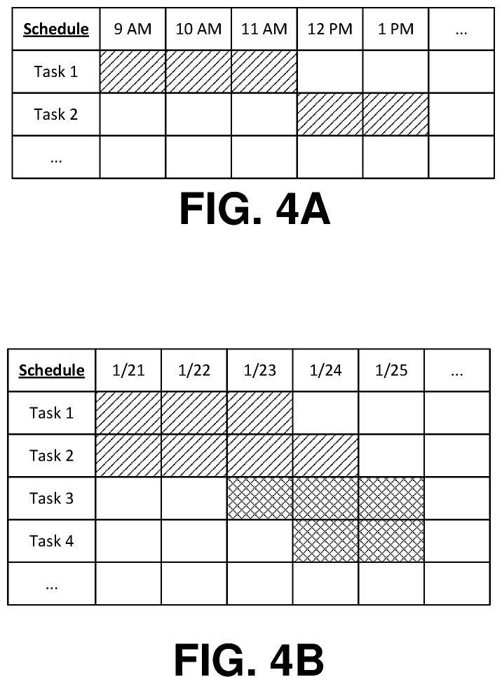

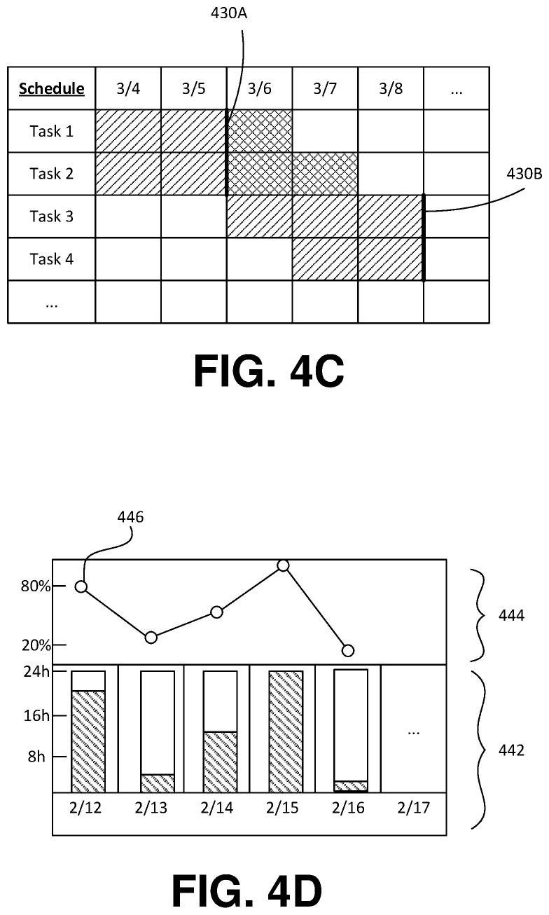

The TMS 110 includes a user interface engine 112 and a turnaround optimization engine (TOE) 114. The TOE 114 generates optimized schedules, and is described in further detail below with reference to FIG. 2. The user interface engine 112 generates user interfaces for updating or interacting with the TMS 110. In particular, the user interface engine 112 may provide user interfaces for display via a client application executing on a client device 120 of a user (e.g., a manager or administrator). A user may update or input tasks to the TMS 110 and receive an optimized schedule in response. For example, the generated user interfaces may display a visual representation of the optimized schedule, such as a calendar, Gantt chart, or other representation, to enable the user to understand the optimized schedule. Various user interfaces that may be generated by the user interface engine 112 in various embodiments are described below with reference to FIG. 4.

The client device 120 is a device used by a user to interact with the turnaround management system 110, e.g., to view one or more user interfaces representing an optimized schedule. The client device 120 includes one or more computing devices capable of processing data as well as transmitting and receiving data over the network 130. For example, a client device 120 may be a desktop computer, a laptop computer, a mobile phone, a tablet computing device, an Internet of Things (IoT) device, or any other device having computing and data communication capabilities. Each client device 120 includes a processor for manipulating and processing data and a storage medium for storing data and program instructions associated with various applications. The storage medium may include both volatile memory (e.g., random access memory) and non-volatile storage memory such as hard disks, flash memory, and external memory storage devices. Each client device 120 may further include a display capable of displaying a user interface, depending upon the embodiment.

The database 140 may be one or more relational or non-relational databases that can store data including tasks and their properties and constraints, schedules, user interfaces, and so on. Although the term database is used, is some embodiments, some or all of the data may be stored in other manners.

The network 130 may comprise any combination of local area and wide area networks employing wired or wireless communication links. In one embodiment, network 130 uses standard communications technologies and protocols. For example, network 130 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 130 include multiprotocol label switching (MPLS), transmission control/protocol/Internet protocol (TCP/IP), hypertext transport protocol (HTTP), simple mail transfer protocol (SMTP), and file transfer protocol (FTP). Data exchanged over the network 130 may be represented using any format, such as hypertext markup language (HTML) or extensible markup language (XML). In some embodiments, all or some of the communication links of the network 130 may be encrypted.

FIG. 2 illustrates an example block diagram of a turnaround optimization engine (TOE) 114, according to one embodiment. The TOE 114 determines an optimal (or substantially optimal) schedule based on an input set of tasks. In the embodiment shown, the TOE 114 includes a task analysis engine 205, a graph construction engine 210, and a graph analysis engine 215. In other embodiments, the TOE 114 can contain fewer, different, or additional elements. In addition, the functions may be distributed among the elements in a different manner than described.

The task analysis engine 205 receives a set of tasks, such as from a user input at a user interface of the TOE 114, user input received from the client device 120, automated input received from the client device 120, or from storage in the database 140. In one embodiment, the task analysis engine 205 identifies each property and constraint of each task in the set of tasks and generates a set of formalized parameters for use in the graph construction engine 210. For example, each task may be a data object including a type parameter, one or more constraint parameters, and one or more property parameters, which cumulatively form the set of formalized parameters. The task analysis engine 205 sends the set of formalized parameters to the graph construction engine 210.

The graph construction engine 210 uses the set of formalized parameters to construct a directed acyclic graph where tasks are represented by vertices (“task vertices”) and edges represent constraints and properties. For example, an edge weight may represent properties such as the temporal duration of a task, or the required resources of the task (e.g., ingredients, personnel, or man hours). In an embodiment, an edge weight may correspond to a weighted combination of representations (e.g., numerical values representative of) both the temporal duration of a task and the required resources of the task. Though described below with reference to purely time-based constraints, the principles described herein also apply to such alternative embodiments.

The graph construction engine 210 first generates a directed acyclic graph of vertices (alternatively called nodes) representing tasks with edges representing constraints. The graph construction engine 210 then adds a start vertex to the graph and connects the start vertex to each task vertex with an edge. The graph construction engine 210 then adds a stop vertex to the graph and connects the stop vertex to each task vertex with an edge. The graph analysis engine 215 then uses an algorithm to traverse the graph from the start vertex to the stop vertex one or more times, wherein tasks are scheduled based on the one or more traversals.

In an embodiment, a SAC constraint between two tasks is represented by an edge between two task vertices representing the constrained tasks, where the edge has a weight equal to a time duration for one of (e.g., a temporally second of) the two tasks and a direction towards one of (e.g., a temporally second of) the two tasks.

In an embodiment, a SAS constraint for two tasks is represented by an edge between two task vertices representing the constrained tasks, with a weight equal to the difference in time durations between the two tasks and a direction towards one of the two tasks (e.g., the task with a lesser temporal duration). Depending upon the embodiment, the weight may be negative.

In an embodiment, a ST constraint between two tasks is represented by a pair of SAS constraints between task vertices representing the two tasks, each directed towards one of the task vertices, e.g., a first edge directed towards a first of the task vertices and a second edge directed towards a second of the task vertices.

In an embodiment, a FT constraint between two tasks is represented as a pair of edges between task vertices representing the two tasks, each having zero weight and a direction towards one of the task vertices, e.g., a first edge directed towards a first of the task vertices and a second edge directed towards a second of the task vertices.

In an embodiment, SAD constraints are not represented in the graph.

In an embodiment, SRAP and SAP constraints are substituted by SRAC and SAC constraints and “dummy operations” are added to the graph, where each dummy operation has an ST constraint to the first task and a duration of time or progress offset. When the optimized schedule is computed, the dummy operations are removed.

In an embodiment, a FBD constraint of a task is represented by the edge from the task vertex representing the task to the stop vertex, with a weight according to Equation 1:

Weight=T_{T}−(T_{C}−T_{S}) (Equation 1)

Where T_{T} is the total temporal duration of the schedule, T_{C} is the value of the time property corresponding to the FBD constraint (the time by which the task must be completed), and T_{S} is the schedule start time. The edge is directed towards the stop vertex. Depending upon the embodiment, the time property may be a parameter included in the set of tasks (e.g., associated with the task or part of a data structure for the task). The schedule start time may be set by an administrator of the TMS 110 or may be based on a current time at runtime of the graph construction engine 210 (e.g., a time at which the graph construction engine 210 generates the graph, as measured by a clock of the turnaround management system 110). The total temporal duration of the schedule may be set by an administrator or estimated by the TMS 110. For example, the TMS 110 may generate a schedule without FBD constraints to produce an estimate of schedule duration, then regenerate the schedule with FBD constraints to get an optimized schedule that respects FBD constraints. In embodiments where a schedule cannot be produced satisfying all FBD constraints in the set of tasks, the graph construction engine 210 ignores the FBD constraint of one or more of the tasks. The tasks for which FBD constraints are ignored may be selected based on, for example, a relative priority of the tasks with FBD constraints, or on a relative path length of different paths including the tasks.

In an embodiment, each edge from the start vertex to a task vertex has a weight equal to the temporal duration of the task represented by the task vertex. Each edge from a task vertex to the stop vertex has a weight of zero unless otherwise set, e.g., by a FBD constraint.

In an embodiment, the graph construction engine 210 re-weights edges based on a priority property of the tasks represented in the graph. For example, edges corresponding to task vertices representing tasks of a first priority may be reweighted by multiplying the edge's weights by a first factor, and edges corresponding to task vertices representing tasks of a second priority may be reweighted by multiplying the edge's weights by a second factor. A higher priority may correspond to a greater multiplicative factor.

In an embodiment, the graph analysis engine 215 weights each edge as the negation of the actual cost (e.g., in terms of time or personnel), which enables finding the longest paths with the original weights using an algorithm for the shortest path on negative weights. The graph analysis engine 215 then determines longest time paths through the graph, accounting for the highest cost or greatest constrained tasks before those of lower cost or which are less restricted. In other embodiments, the path may be a longest resources path, or a combined longest time and resources path. A longest resources path is where the edges of the graph are weighted based on required resources (e.g., chemical reactants, specialized equipment, or trained personnel). A combined longest time and resources path corresponds to graphs where edge cost is based on a weighted combination of task temporal duration and required resources.

Depending upon the embodiment, any of a variety of algorithms may be used by the graph analysis engine 215 to traverse the graph. For example, the graph analysis engine 215 may employ a Greedy algorithm or an A* algorithm. Using the algorithm, the graph analysis engine 215 iteratively traverses the graph and selects tasks based on a longest path (e.g., highest total edge weight) through the graph at each iteration. At a given iteration, the task corresponding to the vertex with the longest path through the graph is added to the schedule. In some embodiments, additional tasks corresponding to vertices along the longest path through the graph are also added to the schedule. In either case, edges corresponding to scheduled tasks are set to zero or marked as used, or the task vertices and edges corresponding to scheduled tasks are removed from the graph. In embodiments where task vertices are marked as used upon addition to the schedule, the graph analysis engine 215 ignores such task vertices for subsequent iterations when determining a new longest path through the graph. At a given iteration, if a task in the longest path to the stop vertex can't be scheduled at the iteration (e.g., because of a constraint), the system moves on to the next longest path, etc., until a viable path (e.g., where each task associated with a task vertex in the path can be scheduled at the time of the iteration) is found.

The graph analysis engine 215 continues the iterative process until all tasks are added to the schedule, at which time the graph analysis engine 215 may send the schedule to the user interface engine 112 for conversion into a visual schedule, such as those described below with reference to FIG. 4. Alternatively, the graph analysis engine 215 may directly send the schedule to the client device 120.

In an embodiment, the graph analysis engine 215 accounts for ADR constraints by factoring for remaining daily resources when identifying the longest path. For example, the graph analysis engine 215 discounts longest paths until a longest path is found that requires fewer daily resources (as indicated by one or more properties) than are available for a particular day of the schedule for which it is being scheduled. Accordingly, the graph analysis engine 215 may track how many daily resources are used, per day, by the tasks in the schedule, adjusting as tasks are added. Alternatively, when a task with an ADR constraint has the longest path, it is scheduled at the earliest possible time given the constraint. This may include iteration over several days and checking if there are enough resources to satisfy the ADR constraint, factoring for any ADR constraints of already scheduled tasks.

The graph analysis engine 215 may produce multiple schedules, e.g., using different algorithms. In such embodiments, the graph analysis engine 215 selects the schedule with the shortest total temporal duration as the optimized schedule. In an embodiment, if there are more than one schedule with the same lowest overall total temporal duration, the graph analysis engine 215 selects as the optimal schedule the schedule that minimizes finish time of all tasks with a “completed before date” constraint.

The graph analysis engine 215 can additionally analyze the constructed graph to assess risk, opportunity, and potential delays. In an embodiment, the graph analysis engine 215 sends the determined schedules, assessed risks and opportunities, and expected delays to the user interface engine 112 for generation of a user interface for display to the user at the display of the client device 120. In an embodiment, the graph analysis engine 215 determines a lower bound of the generated schedule, which may be valuable for evaluating the optimality of the generated schedule. The graph analysis engine 215 may generate an optimality score for the generated schedule based on a comparison of the generated schedule to the lower bound.

In one embodiment, the lower bound is calculated using linear programming. The above techniques specify heuristics for scheduling tasks. These heuristics do not guarantee optimality of the schedule. The optimal schedule could theoretically be produced using integer programming. However, using integer programming to formulate the scheduling problem as a set of linear inequalities to be solved by a general solver may be infeasible due to the size of the dataset and the limitations of extant computer systems. As such, the graph analysis engine 215 may use linear programming to approximate the lower bound. Where the integer programming case would be restricted to integer numbers (e.g., all of a trained person, a whole liter of an ingredient, a whole minute of time, etc.), the linear programming case can use fractional values. While it is not realistic to use half of a technician to work on a task, using such assumptions enables production of a theoretical lower bound on the optimal schedule, since the infeasible integer programming problem is relaxed to a linear programming problem that is feasible using extant computer systems. An actual schedule may be assessed by how much one or more metrics (e.g., total time, total cost, etc.) exceed the same metrics calculated using the lower bound. A particular schedule may be considered optimal if the difference between the metrics calculated for that schedule and the metrics calculated from the lower bound is less than a threshold. Where more than one metric is calculated, the difference may be calculated by adding the differences, selecting the largest difference, or using any other suitable combination method.

The graph analysis engine 215 assesses risk for a schedule by adjusting one or more property parameters of one or more tasks in the schedule to simulate imperfect operating conditions, e.g., delay of production of an API due to lack of delivery of a reactant to the facility. The graph analysis engine 215 then regenerates the schedule and compares the regenerated schedule to the original. For example, the graph analysis engine 215 adjusts the temporal duration property of one or more tasks by one hour and regenerates the schedule using the adjusted property parameters. The graph analysis engine 215 then compares the regenerated schedule to the original schedule to assess one or more risks. For example, the graph analysis engine 215 may determine an amount of increase in total temporal duration of the schedule, a percentage of tasks with new positions within the schedule, an amount of increase in tasks that do not satisfy FBD constraints, etc. The graph analysis engine 215 may assess particular risks based on risks specified by user input, and may report the results of the assessment directly to the client device 120, or to the user interface engine 112 for inclusion in a user interface.

Based on the risk assessment, the graph analysis engine 215 may categorize the impact to the schedule of the change to the parameter, e.g., as high risk, medium risk, low risk, or no risk. The categorization of the schedule may depend upon one or more thresholds of amount of increase in total temporal duration, one or more thresholds of amount of increase in tasks that do not satisfy FBD constraints, or one or more other thresholds based on other changes from the original schedule to the regenerated schedule. Using such risk assessment techniques, the graph analysis engine 215 may be used to identify one or more “critical” tasks, the delay of which would cause significant impact on the total temporal duration of the schedule (e.g., greater than a threshold amount of change in total temporal duration).

The graph analysis engine 215 may analyze the constructed graph for potential delays based on a linear regression model developed using historical schedule data. Potential delays are determined as the difference between a scheduled finish time and an actual finish time. For example, if a schedule includes a task that ends at time X, and upon performance of the task it actually ends fifteen minutes after time X, the task had a delay of fifteen minutes. Due to constraints where tasks may depend upon one another, a delay to one task can cause delay to another that depends upon it. The graph analysis engine 215 constructs the linear regression model on historical schedule data, and may be implemented for a particular variable, such as process time preceding a task and process time of the task, task priority, expected total temporal duration of the schedule, and amount of resources used (whether by volume or percentage). The graph analysis engine 215 may construct multiple linear regression models, e.g., for different variables, or based on different historical data, and may update one or more linear regression models are historical schedule data is generated, e.g., as schedules are created. Performance data for schedules, such as actual temporal durations of tasks, actual finish times, and the like, may be entered into the graph analysis engine 215 via a user interface, or may be received from one or more devices performing the tasks.

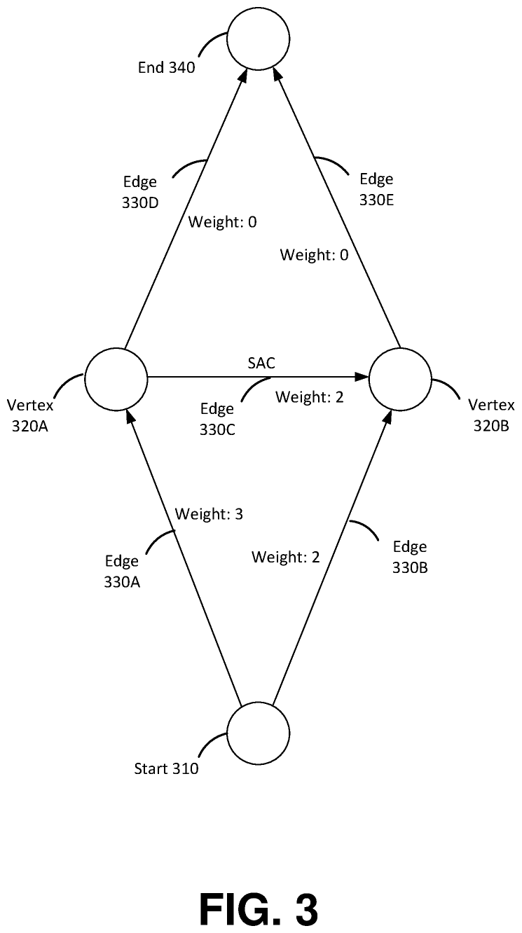

FIG. 3 uses like reference numerals to identify like elements. A letter after a reference numeral, such as “320A,” indicates that the text refers specifically to the element having that particular reference numeral. A reference numeral in the text without a following letter, such as “320”, refers to any or all of the elements in the figures bearing that reference numeral. For example, “320” refers to reference numerals “320A” and/or “320B” in the figures.

FIG. 3 illustrates an example directed acyclic graph (DAG) that may be generated by a TOE 114, according to one embodiment. The DAG includes a start vertex 310, two task vertices 320, and an end vertex 340 (alternatively called the stop vertex, as above), which are connected via edges 330. Start vertex 310 is connected to task vertex 320A by edge 330A and task vertex 320B by edge 330B, respectively. Task vertex 320A is connected to task vertex 320B by edge 330C. End vertex 340 is connected to task vertex 320A by edge 330D and task vertex 320B by edge 330E, respectively. Edges 330A,B connecting the start vertex 310 to task vertices 320A,B have directionality towards the task vertices 320A,B. Edges 330D,E connecting the task vertices 320A,B to the end vertex 340 have directionality towards the end vertex 340. Edge 330C connects vertex 320A to vertex 320B and has directionality towards vertex 320B.

Edge 330A has a weight of 3, indicating the task represented by task vertex 320A takes three time units (e.g., 3 hours) to complete. Similarly, Edge 330B has a weight of 2, indicating that the task represented by task vertex 320B takes two time units (e.g., 2 hours) to complete. Edges 330A,B have these weights because they connect the start vertex 310 and to task vertices 320, and thus are weighted by the temporal duration of the tasks represented by the task vertices 320 to which they connect, as described above with reference to FIG. 2.

Edge 330C has a weight of two, as the edge represents a SAC constraint between task vertices 320A,B and has directionality towards task vertex 320B. The edge 330C has this directionality because the task represented by task vertex 320A is temporally first (that is, the task represented by task vertex 320A must complete before the task represented by task vertex 320B may be performed). As such, the edge 330C has a weight based on the temporal duration of the task represented by task vertex 320B, per the SAC constraint described above with reference to FIG. 2.

Edges 330D,E have weights of zero, as they connect task vertices 320 to the end vertex 340, and neither the task represented by task vertex 320A nor the task represented by task vertex 320B has a FBD constraint.

If the graph analysis engine 215 were to generate a schedule based on the DAG of FIG. 3, the task represented by task vertex 320A would be scheduled in an initial position in the schedule, and the task represented by task vertex 320B would be scheduled in a subsequent position in the schedule. This is because, at a first iteration of a traversal algorithm, the longest path from the start vertex 310 to the end vertex 340 is from the start vertex 310 to task vertex 320A to task vertex 320B to the end vertex 340. This path has a weight of 6, being the sum of the weights of edge 330A, 330C, and E.

A first alternative path through the DAG is from the start vertex 310 to task vertex 320A to the end node 340, with weight equal to the weight of edge 330A summed with the weight of edge 330D, which is a weight of 3. A second alternative path through the DAG is from the start vertex 310 to task vertex 320B to the end node 340, with weight equal to the weight of edge 330B summed with the weight of edge 330E, which is a weight of 2. Both of these alternative paths are shorter, and thus are not selected by the graph analysis engine 215.

On a first traversal of the DAG, vertex 320A is scheduled, as it is the vertex with the longest path. Then, since vertex 320B is the last remaining vertex, it is scheduled. In an embodiment, all task vertices 320 are scheduled after the first iteration of the algorithm and the algorithm would not perform another iteration. In either case, the graph analysis engine 215 sends the generated schedule to the user interface engine 112, the client device 120, and/or the database 140 upon completion of the schedule.

FIG. 4A illustrates an example optimized schedule, according to one embodiment. The schedule may be generated by the TOE 114 and rendered similar to the figure by the user interface engine 112. The schedule includes a table with a plurality of columns and rows, where at least some columns each corresponds to a time or a time segment and at least some rows each corresponds to a task. Cells of the table are filled with a task indicator depending upon whether the task of the row of the cell is scheduled to be performed at the time of the column of the cell, collectively indicating a time window for the task to be performed. For example, three cells in the schedule corresponding to a “Task 1” and 9:00 AM, 10:00 AM, and 11:00 AM, respectively, are filled with diagonal lines to indicate that Task 1 is scheduled to be performed between 9:00 AM and 11:00 AM. Similarly, two cells in the schedule corresponding to a “Task 2” and 12:00 PM and 1:00 PM, respectively, are filled with diagonal lines to indicate that Task 2 is scheduled to be performed between noon and 1:00 PM. Depending upon the embodiment, cells of the table may be filled with a task indicator using any of a variety of graphical elements (alternatively “graphical properties”), including one or more colors and/or patterns. Similarly, the schedule may be rendered using any of a variety of graphical elements, including different lines, line thicknesses, patterns, colors, text, fonts, etc.

FIG. 4B illustrates an example optimized schedule displaying task dependencies, according to one embodiment. The schedule includes a table with a plurality of columns and rows, where at least some columns each corresponds to a time and at least some rows each corresponds to a task. Cells of the table are filled with a task indicator depending upon whether the task of the row of the cell is scheduled to be performed at the time of the column of the cell. For example, three cells in the schedule corresponding to “Task 1” and January 21^{st} through 23^{rd} (1/21, 1/22, 1/23) are filled with diagonal lines to indicate that Task 1 is scheduled to be performed on these three days. Similarly, four cells in the schedule corresponding to “Task 2” and January 21^{st} through 24^{th} (1/21, 1/22, 1/23, 1/24) are filled with diagonal lines similar to those for Task 1, indicating that Task 2 is scheduled to be performed on these four days. Tasks 1 and 2 share a similar fill pattern (slashed lines) to indicate an ST (start together) constraint, where the two tasks must start simultaneously or near-simultaneously (e.g., within a threshold time of one another). The use of a similar fill pattern visually indicates that the two tasks share a constraint. Depending upon the embodiment, cells of the table may be filled with a task indicator using any of a variety of graphical elements, including one or more colors and/or patterns, so long as tasks sharing constraints are filled similarly. The schedule may be rendered using any of a variety of graphical elements, including different lines, line thicknesses, patterns, colors, text, fonts, etc.

In the schedule, three cells corresponding to “Task 3” and January 23^{rd} through 25^{th} (1/23, 1/24, 1/25) are filled with cross hatches to indicate Task 3 is scheduled to be performed on these three days. The fill for these cells is different from that of the cells corresponding to Tasks 1 and 2 to indicate that Task 3 does not share a constraint with Task 1 or Task 2. Two cells in the schedule corresponding to “Task 4” and January 24^{th} through 25^{th} (1/24, 1/25) are filled with cross hatches to indicate Task 4 is scheduled to be performed on these two days. The fill for these cells is similar to those corresponding to Task 3 to indicate that Tasks 3 and 4 share a constraint, more specifically, a FT (finish together) constraint, where two tasks must finish simultaneously or near-simultaneously (e.g., within a threshold time of one another). Thus, the schedule visually represents Tasks 1-4 while also visually indicating constraints among the tasks.

FIG. 4C illustrates an example optimized schedule displaying task deadline satisfaction, according to one embodiment. In some embodiments, e.g., for some sets of tasks, it is impossible to schedule every task in the set such that all deadlines (e.g., FBD, finish before date constraints) are met. In such embodiments, the TMS 110 schedules the tasks based on priority, such that a minimal number of tasks exceed their FBD, or such that the schedule provides for a minimal amount of time spent performing tasks past their FBD. In such embodiments that include the performance of one or more tasks past their FBD, the user interface engine 112 may generate a schedule displaying task deadline satisfaction, as in FIG. 4C.

The schedule includes a table with a plurality of columns and rows, where at least some columns each corresponds to a time and at least some rows each corresponds to a task. Cells of the table are filled with a task indicator depending upon whether the task of the row of the cell is scheduled to be performed at the time of the column of the cell. The schedule additionally includes deadline indicators 430, which each indicate FBDs for one or more tasks. Cells corresponding to performance of a task on dates before the FBD of the corresponding task are visually indicated by a fill of diagonal lines, whereas cells corresponding to performance of a task on dates after the FBD of the corresponding task are visually indicated by a fill of cross hatched lines. Depending upon the embodiment, the fills may be different, as described above, so long as the fills of cells before a FBD and after the FBD are visually distinct. For example, in one embodiment, cells before a FBD of a corresponding task are filled with a solid green coloration, and cells after the FBD of the corresponding task are filled with a solid red coloration.

As seen in the figure, Tasks 1 and 2 both breach the FBD indicated by deadline indicator 430A. Cells corresponding to Tasks 1 and 2 before (e.g., to the left) of the deadline indicator 430A are filled with diagonal lines, whereas cells to the right of the deadline indicator 430A are filled with cross hatched lines. This visually indicates that these tasks do not meet the FBD indicated by the deadline indicator 430A. In contrast, Tasks 3 and 4 are constrained by a FBD indicated by deadline indicator 430B. The schedule indicates that both Tasks 3 and 4 meet the FBD, as all cells corresponding to the two tasks are before (e.g., to the left) of the deadline indicator 430B.

FIG. 4D illustrates an example utilization chart based on an optimized schedule, according to one embodiment. As described above, scheduling a set of tasks factors for the maximum available resources (e.g., physical resources) for performance of the tasks in the set. At any given time within the schedule, a particular amount of the maximum available resources will actually be in use (e.g., will be in use at that moment for performing one or more tasks). The utilization chart illustrated in the figure indicates the amount and percentage of the maximum available resources used throughout the dates and/or times covered by a corresponding schedule, which may represent an efficiency of resource use. The utilization chart indicates the amount and percentage of the maximum available resources used from February 12^{th} through February 16^{th} (2/12, 2/13, 2/14, 2/15, 2/16) for a schedule that schedules the performance of tasks on at least these dates. Depending upon the embodiment, the utilization chart may indicate use of one resource or a plurality of resources (e.g., the average usage of the plurality).

The utilization chart includes both a bar chart section 442 and a line chart section 444. The bar chart section 442 includes a bar chart diagram representative of the use of resources, as an amount of maximum available resources, on a daily basis (where each day is a time bucket). In alternative embodiments, the time buckets of the bar chart may be different windows of time.

The bar chart diagram of the figure includes one bar per day representative of the amount of time spent performing scheduled tasks that day. The bar chart diagram may be labeled to indicate the amount of the maximum available resources (e.g., 24 hours) used, where each bar is filled proportionally to the amount of time spent performing scheduled tasks on the day corresponding to the bar. For example the bar corresponding to February 12^{th} (2/12) is filled approximately to represent 19 hours of usage, whereas the bar corresponding to February 13^{th} (2/13) is filled approximately to represent 6 hours of usage, indicating that approximately 80% of the maximum available resources were used on February 12^{th}, but only approximately 25% of the maximum available resources were used on February 13^{th}. Though the figure illustrates the proportional filling of each bar using diagonal lines, in other embodiments other fill techniques, such as those described above, may be employed.

The line chart section 444 includes a line chart diagram that also represents the use of resources, on a daily basis, but as a percentage of maximum available resources (rather than as an amount of the maximum available resources, as in the bar chart diagram). The line chart diagram includes one point element per day, with a line connecting each pair of adjacent points elements. Each point element is associated with a different day, e.g., one of February 12^{th} through February 16^{th}, and is positioned within the line chart diagram based on the percentage of the maximum available resources used on the day corresponding to the point element. The line chart diagram may additionally include labels indicating percentages of the maximum available resources used, such that point elements in parallel with a particular label correspond to the percentage indicated by the label. For example, for February 12^{th}, approximately 80% of the maximum available resources are scheduled for use, and the corresponding point element 446 is situated in line with an 80% label.

In alternative embodiments, the granularity of time in the utilization chart may differ from the daily granularity of the figure. For example, in alternative embodiments, the utilization chart may be granular to the month, to the week, to the hour, or to the minute. Depending upon the embodiment, the utilization chart may include exclusively one of the bar chart section 442 and the line chart section 444, both, or both as well as additional sections.

In an embodiment, the TOE 114 generates an equipment allocation chart. The equipment allocation chart includes a grid with a plurality of rows and columns. Each of the plurality of rows represents a resource (e.g., a piece of equipment, such as a vessel) and each of the plurality of columns represents a date (or other time period). One or more cells in the grid are labeled to indicate a task, representing that the equipment represented by the row corresponding to the cell will be used for the task labeled at the cell for the time period represented by the column. Each task may be represented within the equipment allocation chart by labeling one or more cells.

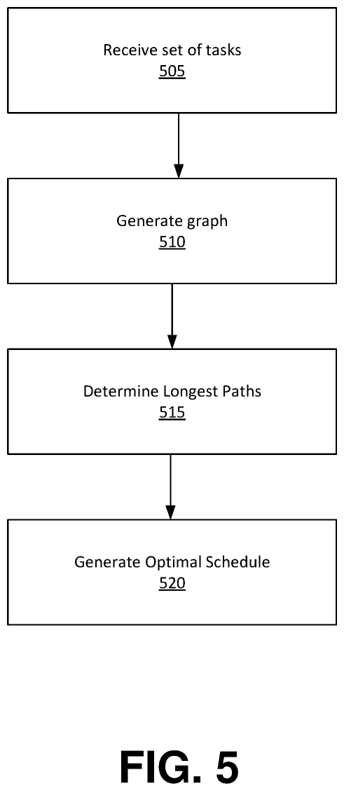

FIG. 5 illustrates an example process flow for determining an optimized schedule, according to one embodiment. The steps of FIG. 5 are illustrated from the perspective of the TMS 110 performing the method. However, some or all of the steps may be performed by other entities and/or components. In addition, some embodiments may perform the steps in parallel, perform the steps in different orders, or perform different steps.

In the embodiment shown in FIG. 5, the TMS 110 receives 505 a set of tasks, such as from the database 140 in response to a request form a user via a user interface. The set of tasks includes, for each task, one or more parameters, such as a temporal duration, or a constraint, which may involve another task in the set. The TMS 110 generates 510 a directed acyclical graph (DAG) based on the set of tasks. The TMS 110 may generate 510 the DAG by generating a task vertex for each task, as well as a start vertex and a stop vertex. The TMS 110 connects each task vertex to the start vertex and to the stop vertex via edges, and may connect one or more task vertices to one another via edges based on parameters (e.g., constraints) in the set of tasks. The TMS 110 assigns each edge a weight based on which vertices are connected by the edge as well as the parameters of at least one task vertex connected by the edge.

The TMS 110 determines 515 a longest path from each vertex representing a task to the end vertex through the DAG using an algorithm based on edge weight and directionality, such as a Bellman-Ford algorithm, and generates 520 an optimal schedule based on the longest paths using an algorithm such as an A* algorithm or a Greedy algorithm. The TMS 110 may perform a plurality of iterations of longest path determination 515, removing or marking task vertices from the DAG after each iteration, e.g., after adding the tasks represented by the task vertices in the longest path of the iteration to the schedule, and ignoring those task vertices when determining a longest path at a next iteration of the determination 515 process.

Depending upon the embodiment, the TMS 110 may generate one or more user interfaces based on the generated 520 optimal schedule. The TMS 110 may generate one or more additional schedules, e.g., schedules that prioritize different parameters. The TMS 110 may perform risk analysis, potential delay analysis, benchmarking via a lower bound of the optimal schedule, or other analyses. The TMS 110 may create or modify one or more linear regression models. The TMS 110 may send the generated schedule to the database 140 for storage.

### Physical Components

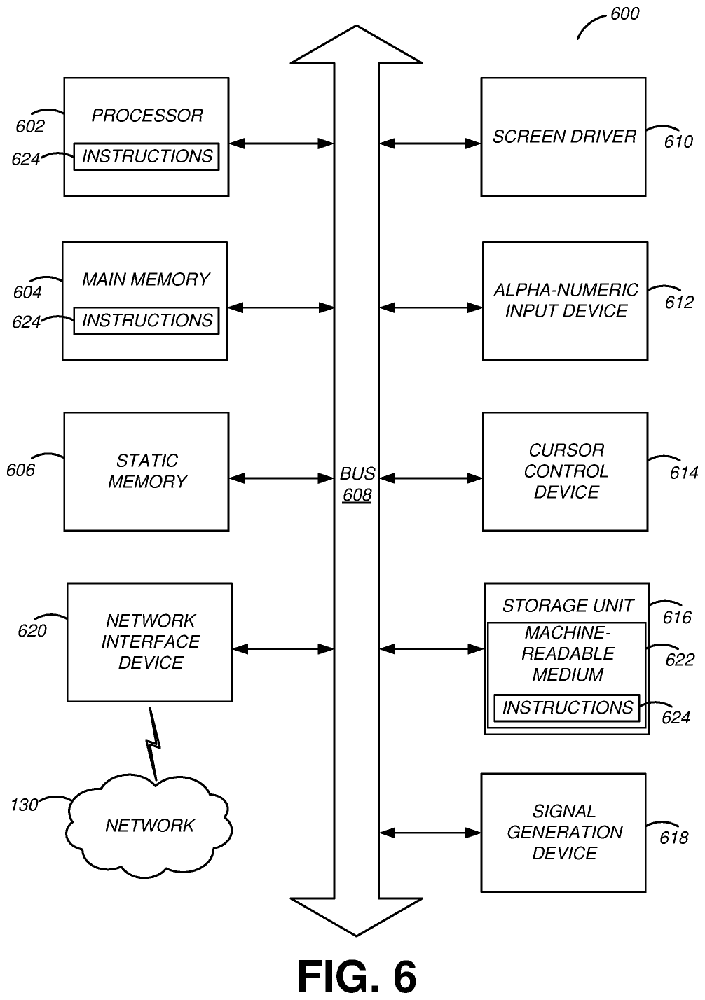

FIG. 6 is a block diagram illustrating components of an example machine able to read instructions from a machine-readable medium and execute them in one or more processors (or controllers) in accordance with one example embodiment.

Specifically, FIG. 6 shows a diagrammatic representation of an example form of a computer system 600. The computer system 600 can be used to execute instructions 624 (e.g., program code or software) for causing the machine to perform any one or more of the methodologies (or processes) described herein. The machine may operate as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 624 (sequential or otherwise) that specify actions to be taken by that machine. Further, while only a single machine is illustrated, the term “machine” shall also be taken to include any collection of machines that individually or jointly execute instructions 624 to perform any one or more of the methodologies discussed herein. In addition, it is noted that not all the components noted in FIG. 6 may be necessary for a machine to be configured to execute the systems and/or processes described within the disclosure.

The example computer system 600 includes one or more processing units (generally processor 462). The processor 602 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 600 also includes a main memory 604. The computer system may include a storage unit 616. The processor 602, memory 604, and the storage unit 616 communicate via a bus 608.

In addition, the computer system 600 can include a static memory 606, a graphics display 610 (e.g., to drive a plasma display panel (PDP), a liquid crystal display (LCD), or a projector). The computer system 600 may also include alphanumeric input device 612 (e.g., a keyboard), a cursor control device 614 (e.g., a mouse, a trackball, a joystick, a motion sensor, or other pointing instrument), a signal generation device 618 (e.g., a speaker), and a network interface device 620, which also are configured to communicate via the bus 608.

The storage unit 616 includes a machine-readable medium 622 on which is stored instructions 624 (e.g., software) embodying any one or more of the methodologies or functions described herein. The instructions 624 may also reside, completely or at least partially, within the main memory 604 or within the processor 602 (e.g., within a processor's cache memory) during execution thereof by the computer system 600, the main memory 604 and the processor 602 also constituting machine-readable media. The instructions 624 may be transmitted or received over a network 626 via the network interface device 620.

While machine-readable medium 622 is shown in an example embodiment to be a single medium, the term “machine-readable medium” should be taken to include a single medium or multiple media (e.g., a centralized or distributed database, or associated caches and servers) able to store the instructions 624. The term “machine-readable medium” shall also be taken to include any medium that is capable of storing instructions 624 for execution by the machine and that cause the machine to perform any one or more of the methodologies disclosed herein. The term “machine-readable medium” includes, but not be limited to, data repositories in the form of solid-state memories, optical media, and magnetic media.

### Additional Considerations

The disclosed configuration provides benefits and advantages that include, for example, optimized or near-optimized scheduling of tasks, allowing for less turnaround and therefore increased efficiency. The disclosed techniques enable a more efficient user interface between a TMS 110 and a factory manager or operator. Such an interface may enable the operator to quickly determine the impact of various scheduling decisions and update equipment configuration accordingly, balancing various factors including available resources and likelihood of delays. Thus, the disclosed techniques may improve the operation of the TMS 110 and/or the factory equipment managed by the TMS. The techniques described herein also provide for increased granularity (e.g., scheduling tasks per quarter of the day versus per day), which creates a more reliable production schedule, and can free up time for scheduling additional tasks. The techniques described herein also enable the generation of multiple schedules based on factors such as different task priorities, enabling the comparison of various scheduling options for a set of tasks, e.g., to achieve different goals. The techniques described herein also allow for improved forecasting of task scheduling, enabling projections of task schedules farther ahead in the future than previous techniques, as well as more frequent updates, enabling more accurate representations of progress towards finishing tasks. The techniques described herein also provide for risk analysis, opportunity analysis, and expected delay prediction.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIGS. 1-2. Modules may constitute either software modules (e.g., code embodied on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 602, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for indexing data entries that may be executed through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A non-transitory computer-readable storage medium storing computer program instructions that, when executed by a processor, cause the processor to:
receive a set of tasks, wherein each task comprises one or more properties and one or more constraints;
generate a directed acyclic graph based on the set of tasks, wherein each task in the set of tasks is represented by a node in the directed acyclic graph, one or more edges in the directed acyclic graph each represent one or more of the constraints, and at least one of the one or more edges is weighted based on at least one of the one or more properties;
determine longest paths through the directed acyclic graph;
generate an optimized schedule based on the longest paths;
generate for display a graphical user interface (GUI) based on the optimized schedule, the GUI comprising:
a table representing time windows; and
a task indicator corresponding to a task in the set of tasks, wherein the task indicator overlays the table based on a time window from the optimized schedule for the corresponding task to be performed.

2. The non-transitory computer-readable storage medium of claim 1, wherein determining the longest paths through the directed acyclic graph comprises determining longest time paths from nodes representing tasks to an end node of the directed acyclic graph, the longest time path for a given node representing a task associated with the given node, wherein at least one of the edges in the directed acyclic graph is weighted based on a time to complete property of at least one of the tasks of the pair of tasks represented by the nodes connected by the edge.

3. The non-transitory computer-readable storage medium of claim 1, wherein determining the longest paths through the directed acyclic graph comprises determining longest resources paths from nodes representing tasks to an end node of the directed acyclic graph, the longest resources path for a given node representing a task associated with the given node, wherein at least one of the edges in the directed acyclic graph is weighted based on a required resources property of at least one of the tasks of the pair of tasks represented by the nodes connected by the edge.

4. The non-transitory computer-readable storage medium of claim 1, wherein determining the longest paths through the directed acyclic graph comprises determining combined longest time and resources paths from nodes representing tasks to the end node, the combined longest time and resources path for a given node representing a task associated with the given node, wherein at least one of the edges in the directed acyclic graph is weighted based on both a time to complete property and a required resources property of at least one of the tasks of the pair of tasks represented by the nodes connected by the edge.

5. The non-transitory computer-readable storage medium of claim 1, wherein the computer program instructions further cause the processor to:
identify risky tasks in the set of tasks, comprising:
simulate an alteration to at least one of the one or more properties;
generate a new optimized schedule based on the set of tasks including the simulated alteration; and
determine an impact of the simulated alteration based on the new optimized schedule.

6. The non-transitory computer-readable storage medium of claim 1, wherein the computer program instructions further cause the processor to:
determine a lower bound to the optimal schedule, comprising:
generate a second optimized schedule based on the set of tasks using linear programming; and
determine an optimality score of the optimized schedule based on the lower bound, comprising:
determine a first metric for the optimized schedule;
determine first metric for the second optimized schedule; and
compare the first metric for the optimized schedule to the first metric for the second optimized schedule.

7. The non-transitory computer-readable storage medium of claim 1, wherein the computer program instructions further cause the processor to:
determine an expected delay for at least one task of the set of tasks based on a regression model and the optimized schedule.

8. The non-transitory computer-readable storage medium of claim 1, wherein the computer program instructions further cause the processor to:
generate for display a graphical user interface (GUI) based on the optimized schedule, the GUI comprising:
a table comprising a plurality of columns and rows, wherein at least one column corresponds to a time segment and at least one row corresponding to one task of the set of tasks;
a first task indicator corresponding to a first task of the set of tasks, wherein the first task indicator overlays a first row of the plurality of rows that corresponds to the first task and one or more columns of the table, wherein the first task indicator represents a first time window for the first task to be performed; and
a second task indicator corresponding to a second task of the set of tasks, wherein the second task indicator overlays a second row of the plurality of rows that corresponds to the second task and one or more columns of the table, wherein the second task indicator represents a second time window for the second task to be performed;
wherein the first time window and the second time window are based on the optimized schedule and the first task indicator and the second task indicator share at least one visually distinguishing graphical property.

9. The non-transitory computer-readable storage medium of claim 1, wherein the computer program instructions further cause the processor to:
generate for display a graphical user interface (GUI) based on the optimized schedule, the GUI comprising:
a table comprising a plurality of columns and rows, wherein at least one column corresponds to a time segment and at least one row corresponding to one task of the set of tasks;
a task indicator corresponding to a task of the set of tasks, wherein the task indicator overlays a row of the plurality of rows that corresponds to the task and one or more columns of the table, wherein the task indicator represents a time window from the optimized schedule for the task to be performed; and
a deadline indicator overlaying the task indicator at a column, wherein the deadline indicator represents a deadline of the task represented by the task indicator;
wherein a portion of the task indicator to one side of the deadline indicator comprises a first graphical property and a portion of the task indicator to another side of the deadline indicator comprises a second graphical property, and the first graphical property and the second graphical property are visually distinguishable.

10. The non-transitory computer-readable storage medium of claim 1, wherein the computer program instructions further cause the processor to:
generate for display a graphical user interface (GUI) based on the optimized schedule, the GUI comprising:
a utilization chart representing an amount and percentage of resources used by tasks over periods of time represented by one or more time buckets, each time bucket representing a different sequential period of time, wherein the percentage of resources used by tasks over each period of time is based on the optimized schedule;
wherein the utilization chart comprises at least one of:
a bar chart, comprising, for each time bucket, a graphical bar indicating the amount of resources used by tasks over the period of time represented by the time bucket, and
a line chart, comprising:
for each time bucket, a graphical point indicating the percentage of resources used by tasks over the period of time represented by the time bucket; and
one or more lines connecting the graphical points of two time buckets representing adjacent periods of time in the sequence.

11. A method, comprising:
receiving a set of tasks, wherein each task comprises one or more properties and one or more constraints;
generating a directed acyclic graph based on the set of tasks, the directed acyclic graph comprising a plurality of nodes and a plurality of edges each connecting a pair of nodes of the plurality of nodes, wherein each task in the set of tasks is represented by one node of the plurality of nodes, at least one edge of the plurality of edges represents the one or more constraints of the tasks represented by the pair of nodes connected by the edge, and at least one edge of the plurality of edges is weighted based on the one or more properties of at least one of the tasks represented by the pair of nodes connected by the edge;
determining longest paths through the directed acyclic graph for nodes of the plurality of nodes to an end node of the plurality of nodes; and
generating an optimized schedule for the set of tasks based on the longest paths.

12. The method of claim 11, wherein determining the longest paths through the directed acyclic graph comprises at least one of:
determining longest time paths from nodes representing tasks to the end node, the longest time path for a given node representing a task associated with the given node, wherein at least one of the edges in the directed acyclic graph is weighted based on a time to complete property of at least one of the tasks of the pair of tasks represented by the nodes connected by the edge;
determining longest resources paths from nodes representing tasks to the end node, the longest resources path for a given node representing a task associated with the given node, wherein at least one of the edges in the directed acyclic graph is weighted based on a required resources property of at least one of the tasks of the pair of tasks represented by the nodes connected by the edge; and
determining combined longest time and resources paths from nodes representing tasks to the end node, the longest resources path for a given node representing a task associated with the given node, wherein at least one of the edges in the directed acyclic graph is weighted based on both a time to complete property and a required resources property of at least one of the tasks of the pair of tasks represented by the nodes connected by the edge.

13. The method of claim 11, further comprising:
identifying risky tasks in the set of tasks, comprising:
simulating an alteration to at least one of the one or more properties;
generating a new optimized schedule based on the set of tasks including the simulated alteration; and
determining an impact of the simulated alteration based on the new optimized schedule.

14. The method of claim 11, further comprising:
determining a lower bound to the optimal schedule, comprising:
generating a second optimized schedule based on the set of tasks using linear programming; and
determining an optimality score of the optimized schedule based on the lower bound, comprising:
determining a first metric for the optimized schedule;
determining first metric for the second optimized schedule; and
comparing the first metric for the optimized schedule to the first metric for the second optimized schedule.

15. The method of claim 11, further comprising:
determining an expected delay for at least one task of the set of tasks based on a regression model and the optimized schedule.

16. The method of claim 11, further comprising:
generating for display a graphical user interface (GUI) based on the optimized schedule, the GUI comprising:
a table comprising a plurality of columns and rows, wherein at least one column corresponds to a time segment and at least one row corresponds to one task of the set of tasks; and
a task indicator, corresponding to the one task, that overlays the one row of the table corresponding to the one task and one or more columns of the table, wherein the task indicator represents a time window from the optimized schedule for the corresponding task to be performed.

17. The method of claim 11, further comprising:
generating for display a graphical user interface (GUI) based on the optimized schedule, the GUI comprising:
a table comprising a plurality of columns and rows, wherein at least one column corresponds to a time segment and at least one row corresponding to one task of the set of tasks;
a first task indicator corresponding to a first task of the set of tasks, wherein the first task indicator overlays a first row of the plurality of rows that corresponds to the first task and one or more columns of the table, wherein the first task indicator represents a first time window for the first task to be performed; and
a second task indicator corresponding to a second task of the set of tasks, wherein the second task indicator overlays a second row of the plurality of rows that corresponds to the second task and one or more columns of the table, wherein the second task indicator represents a second time window for the second task to be performed;
wherein the first time window and the second time window are based on the optimized schedule and the first task indicator and the second task indicator share at least one visually distinguishing graphical property.

18. The method of claim 11, further comprising:
generating for display a graphical user interface (GUI) based on the optimized schedule, the GUI comprising:
a table comprising a plurality of columns and rows, wherein at least one column corresponds to a time segment and at least one row corresponding to one task of the set of tasks;
a task indicator corresponding to a task of the set of tasks, wherein the task indicator overlays a row of the plurality of rows that corresponds to the task and one or more columns of the table, wherein the task indicator represents a time window from the optimized schedule for the task to be performed; and
a deadline indicator overlaying the task indicator at a column, wherein the deadline indicator represents a deadline of the task represented by the task indicator;
wherein a portion of the task indicator to one side of the deadline indicator comprises a first graphical property and a portion of the task indicator to another side of the deadline indicator comprises a second graphical property, and the first graphical property and the second graphical property are visually distinguishable.

19. The method of claim 11, further comprising:
generating for display a graphical user interface (GUI) based on the optimized schedule, the GUI comprising:
a utilization chart representing an amount and percentage of resources used by tasks over periods of time represented by one or more time buckets, each time bucket representing a different sequential period of time, wherein the percentage of resources used by tasks over each period of time is based on the optimized schedule;
wherein the utilization chart comprises at least one of:
a bar chart, comprising, for each time bucket, a graphical bar indicating the amount of resources used by tasks over the period of time represented by the time bucket, and
a line chart, comprising:
for each time bucket, a graphical point indicating the percentage of resources used by tasks over the period of time represented by the time bucket; and
one or more lines connecting the graphical points of two time buckets representing adjacent periods of time in the sequence.

20. A system, comprising:
a processor; and
a non-transitory computer-readable storage medium storing computer program instructions that, when executed by a processor, cause the processor to:
receive a set of tasks, wherein each task comprises one or more properties and one or more constraints;
generate a directed acyclic graph based on the set of tasks, the directed acyclic graph comprising a plurality of nodes and a plurality of edges each connecting a pair of nodes of the plurality of nodes, wherein each task in the set of tasks is represented by one node of the plurality of nodes, at least one edge of the plurality of edges represents the one or more constraints of the tasks represented by the pair of nodes connected by the edge, and at least one edge of the plurality of edges is weighted based on the one or more properties of at least one of the tasks represented by the pair of nodes connected by the edge;
determine longest paths through the directed acyclic graph for nodes of the plurality of nodes to an end node of the plurality of nodes; and
generate an optimized schedule for the set of tasks based on the longest paths.
